(19) United States
(12) Patent Application Publication
(10) Pub. No.: US 2004/0018087 A1
(43) Pub. Date: Jan. 29, 2004

(54) Texas turnstile WindCatcher

(76) Inventor: Edmund Scott Dow, San Marcos, TX (US)

Correspondence Address: Ed Dow, 1414 Belvin, San Marcos, TX, 78666, US

(21) Appl. No.: 10/206,413

(22) Filed: Jul. 29, 2002

(51) Int. Cl. F03D 3/06

(52) U.S. Cl. 416/119; 416/117

(57) ABSTRACT

The Texas Turnstile WindCatcher uses a rigid upper sail to create a low pressure area that draws up a flexible lower sail to it as the wind passes over both sails on the return side of a vertical axis windmill. This aerodynamic action reduces the wind resistance of the sails on their return into the wind. This same action acts as a self-damper in high winds because the spinning of the rotor causes the sails to close and resist opening until the spin slows.

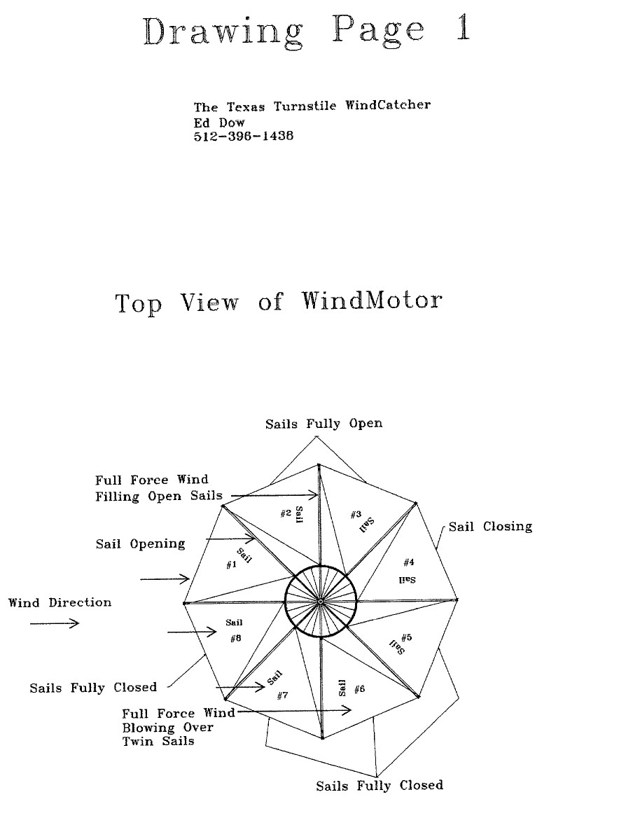

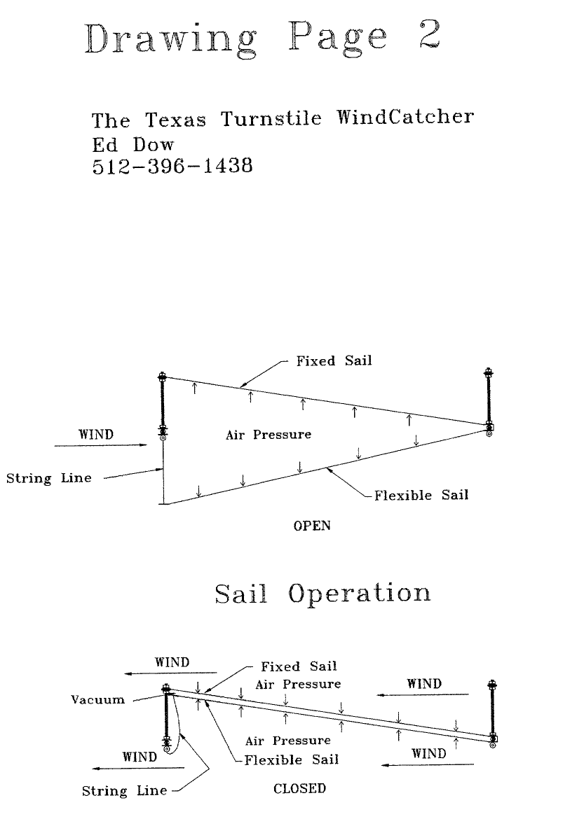

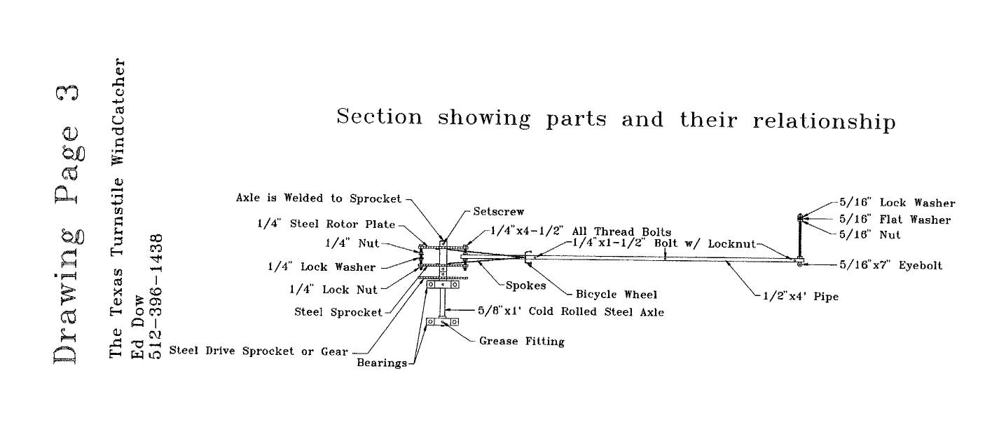

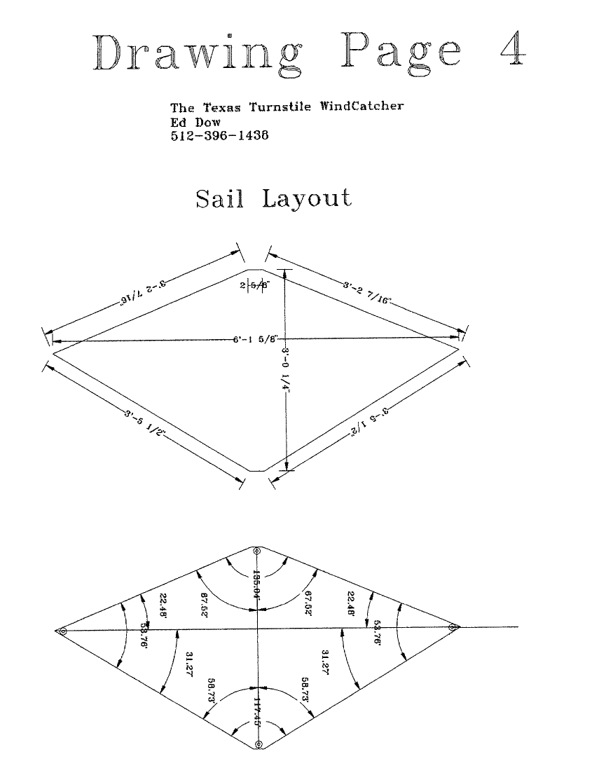

### CROSS-REFERENCE TO RELATED APPLICATIONS

Not Applicable

### STATEMENT REGARDING FEDERALLY SPONSORED RESEARCH OR DEVELOPMENT

Not Applicable

### REVERENCE TO SEQUENCE LISTING, A TABLE, OR A COMPUTER PROGRAM LISTING COMPACT DISK APPENDIX

Not Applicable

### BACKGROUND OF THE INVENTION

The Texas Turnstile WindCatcher is a vertical axis windmill. In the past there have been many different designs of this type of windmill. All these designs had fixed blades or cups that did not collapse when turned into the wind except for one called the Green Windmill created by Robert Green who owns the U.S. Pat. No. 5,823,749. The Green Windmill uses a system of string lines to collapse the sail opposite the sail that is filling with wind so that the sail turning into the wind will offer less wind resistance.

The major operating difference between a vertical axis windmill and a horizontal axis windmill is that the vertical axis windmill does not have to turn its blades into the wind in order to work, which makes it quicker to start than a horizontal axis windmill. One problem a vertical axis windmill has that a horizontal axis windmill doesn't, is that the blade on a vertical axis windmill has to turn into the wind on the opposite side of the axis, thus causing drag and slowing the windmill down. Most vertical axis windmills, except for the Green Windmill that uses sails at a 45-degree angle, have blades or cups at a 90-degree angle to the axis.

A horizontal axis windmill must face the wind in order to have the wind hit the surface of an array of blades or fins at about a 45-degree angle. There is very little drag created with this type of windmill, but by catching the wind at an angle, a horizontal axis windmill is using only half or less of the available power the wind is delivering.

The only way to govern the speed of a horizontal axis windmill in a high wind is to shut it down. This is accomplished by folding the tail fin 90-degrees so that it lies parallel to the blades and turning the blades out of the wind, and perhaps even locking down the rotation of the blades. Or by using airplane propellers that can change their pitch and scrub off excess wind speed.

There is no way to govern the speed of a vertical axis windmill in high winds either, except by shutting it down.

### BRIEF SUMMARY OF THE INVENTION

The Texas Turnstile WindCatcher addresses the problem of wind resistance on the wind catching device that turns into the wind on the opposite side of the axle on a vertical axis windmill. The Texas Turnstile WindCatcher has sails that collapse when turning into the wind by using the aerodynamic wing effect. The sail reopens when the wind blows on the sail from the opposite direction as the rotor turns around on a vertical axis. In extremely high winds the sails stay closed from wind passing over the sails from the spinning of the rotor, thus not allowing the wind enough time, or sail area, to inflate the full sail on the power side of the rotor. The design and weight of the sail, grommet, and string line help to open the sail on the power side.

The Texas Turnstile WindCatcher uses 8 (eight) sails to power its rotor. By using one half of a sail as a wing to create a vacuum to attract the other half of the sail that is flexible, resistance to oncoming wind on the return side of the axis is practically eliminated. The rotation of the windmill rotor uses this same wing action to cause the sails to close in high winds. The only moving parts to cause friction are two grease bearings mounted on the axle.

The Texas Turnstile WindCatcher uses the rotor as a flywheel. It stores the wind energy in the motion of the flywheel and then releases the energy during the blowing of the wind and after the wind dies down. The starting point (the amount of wind it takes to start the rotor to move) and the dampening range (the speed of the rotor that keeps the sails closed) of the rotor/flywheel can be adjusted by using heavier or lighter materials in the construction of the hard parts of the rotor, and by the changing the size of the sails and sail hardware, or by adjusting the workload.

The Texas Turnstile WindCatcher differs from the Green Windmill in a number of ways.

A. The Texas Turnstile WindCatcher uses no cables.

B. The Texas Turnstile WindCatcher uses an aerodynamic action to close its' sails, not a string line system.

C. The Texas Turnstile WindCatcher sails are at a 90-degree angle to the axis.

D. The Texas Turnstile WindCatcher uses 8 sails instead of 4.

E. The Texas Turnstile WindCatcher is self-dampening in high winds and requires no brakes or disconnection.

### BRIEF DESCRIPTION OF THE SEVERAL VIEWS OF THE DRAWING

Drawing Page 1, the “Top View of WindCatcher” shows the layout of each of the 8 sails. It shows the 8 pipes and their relationship to the bicycle wheel. The arrows show how the sails catch the wind and utilize it at its' greatest force 90 degrees to the axle on one side while on the other side the wind blows over the collapsed sails that are turning into the wind. Sail #1 is opening while sail #2 is fully open taking the wind full force at a 90-degree angle to the axle. This is utilizing the wind at its most optimum angle and extracting 100% of the available power from the wind. Sail #3 is still open but the wind is now hitting the sail at a 45-degree angle. The wind is now glancing off this sail while still pushing it around the axle similar to a horizontal axis windmill. Sail #4 is closing here because the wind is no longer filling its sails, and the spinning motion of the rotor is causing the upper sail to act like a wing and the lower sail to fold. The wing shaped upper sail is now creating a low-pressure area underneath it and using air pressure to help draw up the flexible sail to it. This reduces the air drag that all the other vertical windmills have not been able to overcome. Sails #5, 6, 7, and 8 are fully dosed with the lower flap lying up against the upper flap due to the wing effect. If the aerodynamic wing action were not present, the bottom sail would flutter like a flag waving in the wind and cause drag. This aerodynamic wing action creates a smoother and more aerodynamic rotor that is able to turn with less wind resistance than any other vertical windmill. The sail resistance virtually disappears and leaves only the shape of the pipe to resist the wind. This action is the heart of my invention.

Drawing Page 2, the “Sail Operation” view shows how the sails open up when inflated by the wind, and how the flexible bottom flap is sucked and pushed up against the fixed upper flap when the sail turns into the wind. When the wing and sail combination turns into the wind the sails inflate as long as the rotor is not turning too fast to allow the sails to open. At high speeds the aerodynamic affect will dampen the rotor action and stop increasing its speed by keeping the sails closed. When the wind isn't blowing, the bottom sail flap hangs down and open with the weight of the sail, string line and grommet.

Drawing Page 3, the “Section showing parts and their relationship” view shows a cut-away of the bicycle wheel mounted on the axle and one of the pipes and all of its' hardware of nuts and washers. The sails are held to the pipes with 1½″×¼″ bolts, nuts, and flat washers passing through the grommets. The size of the Drive Sprocket can be changed to increase or decrease the outside diameter and the number of teeth. Or it can be replaced with a gear or a pulley. A water pump or an electric generator can be mounted to the same pole the windmill is mounted to. A small diameter sprocket/gear/pulley can be placed on the drive shaft of the motor and then connected to the Drive Sprocket/Gear/Pulley with a bicycle chain, gear, v-belt. The Drive Sprocket/Gear/Pulley rests on the bearing below it for extra support.

Drawing Page 4, the “Sail Layout” view shows the shape of the sails, their dimensions and angles. Grommet locations are noted as well as the string line.

### DETAILED DESCRIPTION OF THE INVENTION

The Texas Turnstile WindCatcher is made of just a few ordinary parts. Start with a single speed rear bicycle wheel for off-road use in order to get a wider and stronger rim. Remove the awe and bearings if any and replace with a ⅝″ cold rolled steel round bar at least 2′ long. A one-piece steel sprocket with a ⅝″ diameter hole and a 7″ diameter outer hub will be used as the upper hub plate for the rotor. These two parts are arc welded together with one end of the steel rod fitting flush with the sprocket face. A one-piece steel sprocket with a ⅝″ diameter hole and a 7″ diameter outer hub also acts as the bottom part of the rotor hub. This will also welded in place to the axle. Drill 8 holes of ¼″ diameter around the outer rim of each steel hub and make sure the ¼″ holes line up through the spokes of the wheel. Secure the wheel to the sprockets and axle with eight 4½×¼″ bolts with washers and nuts. A bushing may be needed to keep the axle centered in the wheel. These bolts sandwich the wheel between the two sprockets and also hold the pipes centered in the wheel. Drill eight ½″ diameter holes in the rim of the bicycle wheel in a geometric pattern. These holes will line up with the holes in the steel hubs. Insert 4′ long ½″ diameter pipes of either galvanized, aluminum, fiberglass EMT, or any composite pipe or rod into each hole in the rim and butt them up near the axis. A ¼″ diameter hole must be drilled into the axis end of each pipe about ½″ from the end. This will allow a ¼″ bolt to be passed through the upper steel sprocket, past the spokes, through the end of the pipe, past more spokes and into a hole in the bottom steel sprocket. Nuts and lock washers are used to secure the pipes to the wheel and hubs. Another ¼″ diameter hole in the pipe located just outside the wheel rim will accept a bolt and washer to hold down one corner of the sail through a grommet. The hole in axle end of the pipe and another 5/16″ diameter hole ½″ inch from the outer end of the pipe should line up vertical to the ground when the wheel is laid horizontal. A 5/16″×7″ long eyebolt is fastened with nuts and lock washers on the outer end of each pipe. There is another ¼″ diameter hole 1″ from the outer pipe end to hold down the other end of the sail through a grommet. Both sail grommet bolts are at a 90-degree angle to the inner and outer bolt holes.

The sails are described as having an upper flap and a lower flap of the same piece of fabric. The lower flap of the sail is attached to the eye of the outer eyebolt with a 1′ (one foot) long piece of weed eater line that is looped on the ends and fastened with aluminum ferrules. The upper flap is fastened to the opposite end of the long eyebolt with nuts and washers. The sail is rip-stop nylon cut to a lopsided diamond shape with brass grommets fastened to the four opposing corners. The axle can then be passed through 2 bearings spaced at least 1′ apart to hold the WindCatcher to a pole or post. The third sprocket called the Drive Sprocket can be connected to any device that can be mounted to the same pole and driven by a chain. A large sprocket with a high number of teeth can be connected to a smaller sprocket with fewer teeth to create a higher rpm. Or a pulley or a gear can be used for the Drive Sprocket to use a belt or another gear to drive a generator or water pump. This Drive Sprocket fits on the axle under the bottom sprocket. More than one Drive Sprocket can be used to drive more motors.

The action of the design uses the wind to fill a sail that is hanging open to catch the wind. When the rotor rotates, the pipe that the sail is mounted on uses the wind and the aerodynamic wing vacuum effect to fold the bottom sail flap around the pipe and push it up against the upper sail flap thus reducing the resistance of an open sail. There are two parts to each sail, an upper flap and a lower flap. The upper flap is fixed to one end of an eyebolt and the lower flap is tethered to the other end of the eyebolt with a string line that allows the lower flap to move up and down depending on which way the wind is coming from. The only moving parts are the axle and the bottom sail flaps and string lines. All wear and stress is absorbed in the 2 (two) bearings that will need to be maintained with grease. The sails are mounted at a 90-degree angle to the axis to ensure maximum transference of energy from the wind to the axle. In high winds the sails stay closed.

1. What I claim as my invention is a vertical axis windmill that uses sails mounted on cylindrical rods or pipes in a radial fashion so as to cause the bottom sail flap to fold up under the top sail flap when the wind blows over both said sail flaps from one direction. The said fixed top sail flap acts like a wing and creates a low pressure area on its underneath side as it moves into the air stream. The said flexible lower sail flap is sucked up into this said low-pressure area and lies up against the said underneath side of the said fixed upper sail flap. This aerodynamic action reduces the wind resistance of the said sail flaps as they turn into the wind. When combined in an array of eight pipe and sail combinations in a bicycle wheel attached to an axle, these sail and pipe combinations act as a more efficient wind catching device for a vertical axis windmill. When the said sail and pipe combinations catch the wind with open sails on one side of the axis, the said sail and pipe combinations on the other side of the axis are folded and reducing wind resistance as they turn into the wind.

2. This same aerodynamic action as described in claim #1 acts as a self-damper to keep the windmill from spinning too fast. As the rotor builds up to its top speed from the wind that is blowing over the entire WindCatcher, the wind passing over the said sail and pipe combinations will act in a self-dampening way in high winds by keeping the said sail flaps closed and unavailable to accept the wind on the power side of the axle. Until the wind speed is reduced over the said sail and pipe combinations, or a load is placed on the windmill to slow the said rotor down (thus reducing the wind speed over the said sail and pipe combinations), the said rotor will reach its stall rotation speed where the sails are being held closed all the time.

3. The entire windmill as described in claim #1, excluding any tower or pole, is also a flywheel. By using large enough sails, a balanced heavy rotor can be turned easily in low wind speeds. Once the weight of the flywheel starts spinning, it works like a heavy water wheel and even keeps spinning for a while after the wind stops. By increasing the size of the sail and pipe combinations and the weight of the said rotor and the number of sail and pipe combinations, a more powerful windmill is created that can perform heavier workloads.

4. Two or more Texas Turnstile WindCatchers, each one as described in claim #1, can be stacked on the same axle thus creating a windmill that is twice as powerful and twice as productive on one single tower.

5. The windmill as described in claim #1 whereas the upper sail flap is made of aluminum or plastic or any other rigid material.

6. The windmill as described in claim #1 using a material called rip-stop nylon for use as the sails.

7. The windmill as described in claim #1 using a canvas fabric for use as the sails.

8. The windmill as described in claim #1 using a silk fabric for use as the sails.

9. The windmill as described in claim #1 using quick-change metal fasteners instead of bolts to connect the said pipes or rods to the bicycle wheel.

10. The windmill as described in claim #1 using a metallic or plastic gear instead of a steel sprocket for the Drive Sprocket.

11. The windmill as described in claim #1 using a pulley in place of a sprocket for the Drive Sprocket.

12. The windmill as described in claim #1 using a metal plate, in any shape from round to square to octagon, in place of the bicycle wheel wherein the said sail pipes or rods are fastened to the said plate with quick-change or regular metal fasteners or welded in place.

13. The windmill as described in claim #1 using a plastic plate, in any shape from round to square to octagon, in place of the bicycle wheel wherein the said sail pipes or rods are fastened to the said plate with quick-change or regular metal fasteners, or by being screwed in.

14. The windmill as described in claim #1 scaled down and the hard parts made of wood or plastic including the bearings.

15. The windmill as described in claim #1 using fewer than 8 (eight) sail and pipe combinations.

16. The windmill as described in claim #1 using more than 8 (eight) sail and pipe combinations.
